(19) United States
(12) Patent Application Publication
(10) Pub. No.: US 2018/0302158 A1
(43) Pub. Date: Oct. 18, 2018

(54) LUMINAIRE SYSTEM FOR OPTICAL WIRELESS COMMUNICATION

(71) Applicant: PURELIFI LIMITED, Edinburgh (GB)

(72) Inventor: Alexander George Norval, Edinburgh (GB)

(73) Assignee: PURELIFI LIMITED, Edinburgh (GB)

(21) Appl. No.: 15/955,502

(22) Filed: Apr. 17, 2018

(30) Foreign Application Priority Data
Apr. 18, 2017 (GB) 1706127.6

(51) Int. Cl. H04B 10/11; F21V 23/00; F21V 33/00; H04B 10/516; H04B 10/60

(52) U.S. Cl. CPC H04B 10/11; F21V 23/003; H04B 10/60; H04B 10/516; F21V 33/00

(57) ABSTRACT

An optical wireless communication (OWC) enabled luminaire system comprises at least one radiation source; a driver apparatus configured to drive the at least one radiation source to produce modulated radiation comprising or representing an OWC signal; a plurality of outputs configured to output modulated light that comprises or is generated using the modulated radiation produced by the at least one radiation source, wherein the plurality of outputs are positioned at substantially different locations that are remote from the at least one radiation source; and at least one guide configured to guide the modulated radiation from the at least one radiation source to the plurality of outputs.

### FIELD

The present invention relates to a luminaire system that is configured for use in optical wireless communication, for example LiFi communication.

### BACKGROUND

It is known to provide wireless data communications by using visible light (or infrared or ultraviolet light) instead of radio frequencies to transmit and receive data wirelessly between devices. Data may be transmitted using light by modulating an intensity of the light. The light used may be coherent or incoherent. Methods that use light to transmit data wirelessly may be referred to as visible light communications (VLC) or optical wireless communications (OWC).

Wireless networks using visible light may in some circumstances allow a higher data capacity and greater energy efficiency than radio frequency wireless networks, and may also be used to replace point-to-point infrastructure in locations where conventional infrastructure does not exist or is too expensive to build.

LiFi (light fidelity) is a form of visible light communication which may in some circumstances be considered to be analogous to WiFi (wireless fidelity) in radio-frequency communications.

Striplights are widely used in the lighting industry. Striplights may offer an inexpensive way of giving even illumination over a large area. Striplighting may provide a very wide area of coverage. For example, an illumination angle of a striplight may be around 180 degrees.

Historically, striplights used fluorescent tubes. LED striplights are now available. LED striplights may comprise a number of individual LEDs laid out in a linear strip. For example, an LED striplight may be around 1 metre in length. The LED striplight may comprise a strip of discrete LEDs and an LED driver situated at one end of the LED striplight.

Existing striplights may be unsuitable for use in optical wireless communications, for example in LiFi. Fluorescent tubes are not suitable for LiFi transmission because they cannot be modulated in a manner that is appropriate for LiFi. Existing LED striplights may comprise long lengths of wire between the LED driver and at least some of the LEDs of the LED striplight. Even if the LED driver were to be replaced with an OWC-enabled driver (for example, a LiFi driver), transmitting the driver current through the long wires may significantly degrade the driver current signal. For example, parasitic induction in the wires may reduce a signal bandwidth that can be transmitted from the LED driver to the LEDs.

### SUMMARY

In a first aspect of the invention, there is provided an optical wireless communication (OWC) enabled luminaire system comprising: at least one radiation source; a driver apparatus configured to drive the at least one radiation source to produce modulated radiation comprising or representing an OWC signal; a plurality of outputs configured to output modulated light that comprises or is generated using the modulated radiation produced by the at least one radiation source, wherein the plurality of outputs are positioned at substantially different locations that are remote from the at least one radiation source; and at least one guide configured to guide the modulated radiation from the at least one radiation source to the plurality of outputs.

By using guides to guide modulated radiation away from the radiation source or sources to a plurality of remote outputs, the configuration of the luminaire system may be improved and/or simplified. The radiation source or sources may be placed near to the driver apparatus. Placing the radiation source or sources near to the driver apparatus may reduce signal degradation and/or electromagnetic interference between the driver apparatus and radiation source or sources. The guides may allow light to be emitted over an extended area even when the radiation source or sources are positioned within a relatively small area. The radiation sources may be positioned closer to the driver apparatus than if the radiation sources were positioned at or near the output locations.

Distributing the radiation using guides may allow light emitted from multiple light outputs to be provided by a smaller number of radiation sources, for example a single light source. A localised source of radiation may be used to output light from outputs that are remote from the localised source of radiation.

Each of the outputs may be positioned at a respective predetermined location such that the outputs are distributed over a luminaire of the luminaire system.

The luminaire may be a striplight. The outputs may be distributed along a length of the striplight. The outputs may be spaced apart with respect to a longitudinal axis of the striplight. The outputs may be arranged in a substantially linear arrangement.

A striplight is a commonly used form factor for lighting, for example for office lighting. Providing an OWC enabled luminaire, for example a LiFi enabled luminaire, in the form of a striplight may enable OWC to be implemented in an office setting in a straightforward manner. The OWC enabled striplight may have illumination properties that are similar to those of a conventional (non-OWC enabled) striplight. For example, the modulated light emitted from the outputs may be white light having a desired spectrum.

By using guides to guide the light to the outputs, the form factor of a striplight may be provided without distributing radiation sources (for example, light sources) along the striplight at the locations at which light is to be emitted.

The outputs may be distributed in two dimensions. For example, the luminaire may be a panel light. The outputs may be distributed across a surface of the panel light. The outputs may be distributed in three dimensions. The outputs may be spaced at a regular spacing in one, two, or three dimensions. The outputs may form an array. The outputs may be contiguous.

The at least one radiation source may be positioned adjacent to the driver apparatus. A distance between the at least one radiation source and at least one of the plurality of outputs may be at least 5 cm, optionally at least 10 cm, further optionally at least 20 cm.

The at least one radiation source may be localised in space. The at least one radiation source may be positioned at a single location.

Positioning the source or sources closer to the driver apparatus may minimise driver impedance, which may maximise bandwidth. Producing a driving signal in a driver apparatus adjacent to the at least one radiation source may reduce power consumption and/or power losses. Signal bandwidth may be better than if the driver apparatus were positioned further from the at least one radiation source.

The at least one radiation source may be coupled to the driver apparatus by at least one wire. Positioning the at least one radiation source adjacent to the driver apparatus may reduce the length of the at least one wire, or eliminate the at least one wire. Reducing the length of the at least one wire may reduce parasitic inductance in the at least one wire, which may improve bandwidth. Reducing the length of the at least one wire may reduce electromagnetic interference. Reducing the length of the at least one wire may reduce RF emissions from the at least one wire.

The modulated radiation may comprise at least one of: modulated light, a modulated beam of particles.

The least one radiation source may comprise at least one modulateable light source. The at least one radiation source may comprise a plurality of modulateable light sources. The modulated radiation produced by the at least one radiation source may comprise modulated light.

The at least one modulateable light source may comprise at least one of: a light-emitting diode (LED), a laser, a laser diode, a light-emitting plasma (LEP). The at least one modulateable light source may comprise light sources of different colours, for example red, green and blue light sources. The at least one modulateable light source may comprise at least one source of visible light, infrared light and/or ultraviolet light. The at least one modulateable light source may comprise at least one light source having a wavelength between 100 nm and 1000 nm, optionally between 450 nm and 850 nm.

The modulated light that is output by the plurality of outputs may comprise at least part of the modulated light produced by the at least one radiation source.

The modulated light that is output from the plurality of outputs may be of a power that is sufficient for general lighting purposes, for example to illuminate a room or part of a room. For example, a luminaire of the luminaire system may have an output power in a range of 0.1 W to 100 W, optionally 1 W to 50 W. The modulated light emitted from the luminaire may provide both illumination and OWC data transfer in the illuminated room or part of a room.

The luminaire system may further comprise at least one light-emitting substance or device configured to convert at least part of the modulated radiation produced by the at least one radiation source into modulated light that is output from the plurality of outputs. The at least one light-emitting substance or device may be positioned at or near the plurality of outputs.

Using a light-emitting substance or device to convert at least part of the modulated light from the at least one radiation source into at least part of the modulated light that is output may allow different radiation sources to be used.

The modulated radiation produced by the at least one radiation source may not comprise light, and the at least one light-emitting substance or device may be configured to convert the modulated radiation into modulated light for emission from the plurality of outputs.

The modulated radiation provided by the at least one radiation source may comprise light having a first wavelength or range of wavelengths. The modulated light emitted from the plurality of outputs may comprise modulated light having a second, different wavelength or range of wavelengths. For example, the modulated light provided by the at least one radiation source may comprise a narrower range of wavelengths than the modulated light that is output from the plurality of outputs. The use of a light-emitting substance or device may allow the use of a light source that may not itself be suitable for illumination.

The at least one light-emitting substance or device may comprise at least one photoluminescent material. The at least one light-emitting substance or device may comprise quantum dots. The at least one light-emitting substance or device may comprise at least one phosphor. For example, the light-emitting substance may comprise a yellow phosphor and the at least one modulateable light source may comprise a source of blue light, for example a blue LED or laser. The yellow phosphor and blue light source may combine to give white light.

The at least one light-emitting substance or device may be positioned on a housing of the luminaire system, for example a housing of a luminaire of the luminaire system. The outputs may comprise regions of phosphor that are formed on the housing of the luminaire system.

The at least one radiation source may comprise a source of particles. The at least one radiation source may comprise an electron source. The electron source may comprise at least one of an electron gun, an electron emitter.

The modulated radiation produced by the at least one radiation source may comprise at least one beam of particles. The at least one beam of particles may comprise at least one beam of electrons.

The at least one beam of particles may be transmitted by radiation through a non-conducting medium, for example air or vacuum. Each of the particles (for example, each electron) in the beam of particles may exit the at least one radiation source and arrive at the light-emitting substance or device, at which it is converted into light.

The modulated light emitted from the outputs may comprise at least one of visible light, white light, infrared light, ultraviolet light. The modulated radiation produced by the at least one radiation source may comprise at least one of visible light, infrared light, ultraviolet light.

The luminaire system may further comprise at least one further light source configured to produce light that is not modulated to comprise or represent an OWC signal.

The total light emitted from the luminaire system may be of a power that is sufficient for general lighting purposes, for example to illuminate a room or part of a room. The total light emitted from the luminaire system may comprise light emitted by the at least one further light source in combination with light output from the plurality of outputs.

The at least one further light source may be configured to emit light that is not modulated by the at least one driver apparatus. The at least one further light source may be configured to emit light that is not modulated. The at least one further light source may be configured to emit light that is modulated at a low modulation frequency, for example a frequency that is below 1000 Hz, optionally below 500 Hz, further optionally below 100 Hz. The light emitted by the at least one further light source may not be modulated to transmit data. For example, the light emitted by the at least one further light source may be modulated for dimming only.

The at least one further light source may comprise at least one of: an LED, a laser, a laser diode, an LEP.

The outputs may be configured to output modulated light over a first range of illumination angles. The at least one further light source may be configured to output light over a second, larger range of illumination angles. The illumination angles may be angles relative to an axis of the luminaire, for example a longitudinal axis of the luminaire. A conventional (non-LiFi enabled) striplight may have range of illumination angles of 180°. When mounted to a ceiling, the striplight may illuminate substantially all angles below the ceiling.

The first range of illumination angles may be less than 120°, optionally less than 90°, further optionally less than 60°. The first range of illumination angles may be between 55° and 65°, for example 60°. The second range of illumination angles may be greater than 90°, optionally greater than 120°, further optionally greater than 150°.

By using outputs having one range of illumination angles and further light sources having a different range of illumination angles, the luminaire system may be configured to emit modulated light over an area that is smaller than an area to be illuminated. For example, the luminaire system may be configured to transmit an OWC signal to an area that is directly below the luminaire system, while illuminating a larger area of a room in which it is placed.

The at least one further light source may improve peripheral illumination. The at least one further light source may better replicate the illumination of a conventional striplight, for example a fluorescent striplight. The at least one further light source may extend an illumination pattern to areas that are to be provided with illumination, but not LiFi coverage.

The at least one further light source may be configured to provide light while not providing an OWC signal. The at least one further light source may illuminate an area that is to be provided with light, but not provided with an OWC signal. A LiFi cell may be created which has a smaller cell size than the overall illumination area. The luminaire may provide one or more LiFi atto cells.

The outputs may be configured to output modulated light having a first wavelength or range of wavelengths. The at least one further light source may be configured to output light having a second, different wavelength or range of wavelengths.

The modulated light output from the plurality of outputs may have a narrower bandwidth than the light emitted by the at least one further light source. The modulated light used for OWC transmission may have a narrower bandwidth than the light used for illumination. The at least one further light source may provide wavelengths of light that are not provided by the outputs. For example, the modulated light may comprise red light and the light from the further light sources may comprise green and blue light.

At least some of the further light sources may be interspersed between the outputs. The outputs may occupy a central part of a luminaire of the luminaire system. At least some of the further light sources may occupy a peripheral part of the luminaire.

The further light sources may be positioned such that light from the further light sources is guided by the guides or by further guides to the outputs or to further outputs.

The at least one guide may comprise at least one of: a light conduit, a fibre bundle, an optical pipe, an optical component, a mirror, a convex mirror, a lens, an electron deflector plate. The or each guide may comprise a respective light conduit and a respective optical component.

The at least one guide may change a path of the modulated radiation. For example, the at least one guide may reflect at least some of the modulated radiation. The at least one guide may focus at least some of the modulated radiation. The at least one guide may comprise at least one light conduit configured to contain the modulated radiation. The at least one guide may control a divergence of the modulated radiation, for example by preventing the modulated radiation from diverging. Modulated light that is output from the plurality of outputs may have a higher divergence than light that is contained within the at least one guide.

The at least one guide may comprise a transmission medium through which the modulated radiation is transmitted. At the outputs, the modulated light may be radiated into free space.

The luminaire system may further comprise a mixer configured to mix modulated light emitted by the at least one radiation source and/or by the at least one light-emitting substance or device and/or by at least one further light source to obtain light of a selected colour profile.

The at least one radiation source may comprise radiation sources configured to emit light of different colours (for example, red, green and blue). The mixer may mix the different colours appropriately in order to generate light with an appropriate colour profile suitable for illumination.

The driver apparatus and outputs may be arranged such that outputs are positioned on each side of the driver apparatus with respect to at least one axis of a luminaire of the luminaire system. The at least one radiation source and the outputs may be arranged such that outputs are positioned on each side of the at least one radiation source with respect to at least one axis of the luminaire. The at least one axis of the luminaire may comprise a longitudinal axis of the luminaire. The driver apparatus and/or at least one radiation source may be positioned substantially centrally with respect to the outputs.

The luminaire system may further comprise a receiver configured to receive light that is modulated to comprise or represent a further OWC signal. The receiver may be configured to receive the light comprising or representing the further OWC signal from a further apparatus, for example from a LiFi transmitter in a LiFi dongle or mobile device. The receiver may be configured to receive visible, infrared or ultraviolet light.

The at least one guide may be further configured to guide received modulated light from the plurality of outputs to the receiver. The plurality of outputs may therefore also act as a plurality of inputs with respect to the received modulated light.

The guides may be configured to guide the received modulated light along substantially the same optical path as the modulated radiation. For example, the guides may guide the modulated radiation from the at least one radiation source to the plurality of outputs along at least one optical path, and may guide the received modulated light from the plurality of outputs along at least part of the same at least one optical path in the opposite direction.

The at least one receiver may be co-located with or in proximity to the radiation source.

The at least one receiver may comprise at least one detector. The at least one detector may comprise at least one of: a photodiode, a photomultiplier, an imaging sensor. The at least one receiver may comprise a plurality of receivers distributed within the luminaire.

Integrating a receiver within the luminaire system may allow both transmission and reception of OWC data in a single device, for example at a single location. The luminaire system may be configured for bidirectional optical wireless transmission.

The system may comprise a luminaire that comprises the driver apparatus, at least one further driver apparatus and a plurality of radiation sources. Each of the driver apparatus and the at least one further driver apparatus may be configured to drive a respective at least one of the radiation sources to produce modulated radiation comprising or representing an OWC signal or OWC signals.

The receiver may be included in said luminaire.

The system may comprise at least one further receiver configured to receive light that is modulated to comprise or represent the or a further OWC signal. The receiver and the at least one further receiver may both be included in said luminaire. Each of the receiver and the at least one further receiver may comprise or be associated at least one detector configured to detect said light that comprises or represents the OWC signal and/or the further OWC signal.

The OWC signal may comprise a communication signal, for example in accordance with a selected communication protocol. The OWC signal may comprise a LiFi signal.

A data transmission rate of the OWC signal and/or driving signal and/or modulated light may be at least 1 kbps, optionally at least 1 Mbps, further optionally at least 1 Gbps.

The modulated light may be modulated in accordance with the OWC signal by using at least one of on-off keying, quadrature amplitude modulation, phase shift keying, orthogonal frequency division multiplex, amplitude modulation, frequency modulation.

The driver apparatus may be configured to drive the at least one radiation source to produce modulated radiation comprising or representing a plurality of OWC signals, such that the luminaire system emits modulated light that is representative of each of the plurality of OWC signals. Different parts of the luminaire system, for example different outputs, may be configured to emit different OWC signals. Different radiation sources may produce modulated radiation comprising different OWC signals. Modulated radiation comprising or representing different OWC signals may be guided by different guides.

The luminaire system may comprise or form part of a mobile device. The luminaire system may be portable, for example hand-held. In some optical wireless systems, a ceiling-mounted luminaire may be used to provide downlink data using visible modulated light, and a smaller, mobile luminaire system may be used to provide uplink data using infrared modulated light. By providing the luminaire system as a mobile device or as part of a mobile device, the luminaire system may be relocated at will. The luminaire system may form part of a user's device that is used to access a LiFi system.

The modulated light output by the plurality of outputs may comprise infrared light. By providing an infrared luminaire that emits infrared light from multiple outputs, eye safety constraints may be overcome. Eye safety regulations may set limits on the amount of light that may be emitted from an infrared light source of a given area. For example, a level of emitted infrared light may be restricted to prevent eye damage. By using multiple outputs, light may be spread over the multiple outputs, which may reduce the intensity of infrared light that is emitted in a given area. In some circumstances, it may be possible to radiate a higher total amount of infrared light than would be possible if the light were to be radiated from a single output. A radiant flux emitted by the infrared luminaire may be less than 500 mW, optionally less than 200 mW.

The luminaire system may further comprise a plurality of positionable light emitting units, each light emitting unit comprising a respective one or more of the plurality of outputs. Each of the positionable light emitting units may comprise a respective housing. The at least one guide may comprise a plurality of flexible guides configured to guide the modulated radiation to the outputs in the light emitting units. The flexible guides and light emitting units may positionable to form a desired arrangement of light emitting units.

The light emitting units may be positioned to form a desired configuration of outputs, for example to place outputs above desks or workstations. A flexible and reconfigurable luminaire system may be provided. The use of flexible guides may allow more degrees of freedom for the placement of the light emitting units. Each flexible guide may comprise a flexible light conduit, for example an optical fibre.

The luminaire system may further comprise a signal providing apparatus configured to generate a data signal. The driver apparatus may be configured to receive the data signal from the signal providing apparatus. The driving of the at least one radiation source by the driver apparatus may be based on the data signal.

The signal providing apparatus may be positioned within a housing of the luminaire system. The signal providing apparatus may comprise or form part of at least one of a LiFi transmitter, a LiFi access point. The signal providing apparatus may be unidirectional (transmit only) or bidirectional (transmit and receive). The signal providing apparatus may comprise a or the receiver.

The data signal may comprise or represent OWC data. The OWC data comprised in or represented by the data signal may be the same as, or may at least partially correspond to, the OWC data comprised in or represented by a driving signal with which the driver apparatus drives the at least one radiation source. The data signal and/or driving signal may be modulated using at least one of on-off keying, quadrature amplitude modulation, phase shift keying, orthogonal frequency division multiplex, amplitude modulation, frequency modulation.

In a further aspect of the invention, which may be provided independently, there is provided an optical wireless communication (OWC) enabled luminaire system comprising: at least one receiver; a plurality of inputs configured to receive light that is modulated to comprise or represent an OWC signal; and at least one guide configured to guide the received light from the plurality of inputs to the at least one receiver; wherein the plurality of inputs are positioned at substantially different locations that are remote from the at least receiver.

In a further aspect of the invention, which may be provided independently, there is provided a method comprising: receiving light at each of a plurality of inputs, guiding the received light from the plurality of inputs to at least one receiver, wherein the plurality of inputs are positioned at substantially different locations that are remote from the at least one receiver, and detecting the received light by the at least one receiver thereby to obtain an OWC signal represented by a modulation of the received light.

In a further aspect of the invention, which may be provided independently, there is provided a method comprising: driving by a driver apparatus at least one radiation source to produce modulated radiation comprising or representing an OWC signal; and guiding by at least one guide modulated radiation from the at least one radiation source to a plurality of outputs, wherein the plurality of outputs are positioned at substantially different locations that are remote from the at least one radiation source; and outputting by the plurality of outputs modulated light that comprises or is generated using the modulated radiation produced by the at least one radiation source.

In a further aspect of the invention, which may be provided independently, there is provided an optical wireless communication enabled luminaire comprising a driver apparatus and a plurality of light sources coupled to the driver apparatus by at least one wire, wherein: the driver apparatus is configured to drive the light sources to produce modulated light by transmitting a driving signal on the at least one wire, the modulated light comprising or representing an OWC signal; and the driver apparatus and light sources are arranged such that light sources are positioned on each side of the driver apparatus with respect to at least one axis of the luminaire.

Positioning light sources to each side of the driver apparatus may reduce the length of wire used to connect at least some of the light sources to the driver apparatus. The length of a longest length of wire connecting a light source to the driver apparatus may be shorter than if the driver apparatus were placed at an end of the axis, such that light sources were all arranged on one side of the driver apparatus.

By reducing a length of the at least one wire coupling the driver apparatus to the plurality of light sources, signal degradation in the wires may be reduced. The bandwidth of the OWC signal may be improved. Electromagnetic interference (EMI) may be reduced. RF emissions from the at least one wire may be reduced.

The luminaire may be a striplight. The light sources may be arranged along a length of the striplight. The light sources may be distributed along a longitudinal axis of the striplight. The light sources may be arranged in a substantially linear arrangement.

The light sources may be distributed in two dimensions. The luminaire may be a panel light. The light sources may be distributed across at least one surface of the panel light. The light sources may be distributed in three dimensions. The light sources may be spaced at a regular spacing in one, two, or three dimensions. The light sources may form an array.

The light sources may be distributed such that light sources are positioned on each side of the driver apparatus with respect to the longitudinal axis. The driver apparatus may be positioned substantially centrally with respect to the at least one axis. Positioning the driver apparatus centrally may reduce (for example, minimise) a distance from the driver apparatus to a furthest one of the light sources.

The driver apparatus and light sources may be arranged to substantially minimise a length of the at least one wire coupling the driver apparatus to the light sources.

The luminaire may further comprise at least one further light source configured to produce light that is not modulated to comprise or represent an OWC signal. The light sources may be positioned on an axis of the luminaire. The further light sources may be offset from that axis of the luminaire.

In a further aspect, which may be provided independently, there is provided a method comprising driving by a driver apparatus of a luminaire a plurality of light sources to produce modulated light by transmitting a driving signal on at least one wire, the modulated light comprising or representing an OWC signal; and
a. the driver apparatus and light sources are arranged such that light sources are positioned on each side of the driver apparatus with respect to at least one axis of the luminaire.

There may also be provided an apparatus or method substantially as described herein with reference to the accompanying drawings.

Any feature in one aspect of the invention may be applied to other aspects of the invention, in any appropriate combination. For example, apparatus features may be applied to method features and vice versa.

### BRIEF DESCRIPTION OF THE DRAWINGS

Embodiments of the invention are now described, by way of non-limiting examples, and are illustrated in the following figures, in which:

FIG. 1 is a schematic illustration of an LED striplight in accordance with an embodiment;

FIG. 2 is a schematic illustration of a luminaire in accordance with an embodiment, in which light from a plurality of LEDs is guided through a plurality of light guides;

FIG. 3 is a schematic illustration of a luminaire in accordance with an embodiment, the luminaire comprising both LiFi-enabled and non-LiFi enabled LEDs;

FIG. 4 is a schematic illustration of a luminaire in accordance with an embodiment, in which light from a laser light source is guided through a plurality of light guides;

FIG. 5 is a schematic illustration of a luminaire in accordance with an embodiment, in which electron beams from an electron source are deflected to strike phosphor coated regions;

FIG. 6 is a schematic illustration of a luminaire in accordance with an embodiment, comprising a LiFi-enabled LED unit with flexible fibre bundles to transmit light to remote lighting heads;

FIG. 7 is a schematic illustration of a luminaire in accordance with an embodiment, comprising a laser LiFi unit with phosphor coated lighting heads; and

FIG. 8 is a schematic illustration of a luminaire in accordance with an embodiment, which is configured to emit infrared light.

### DETAILED DESCRIPTION

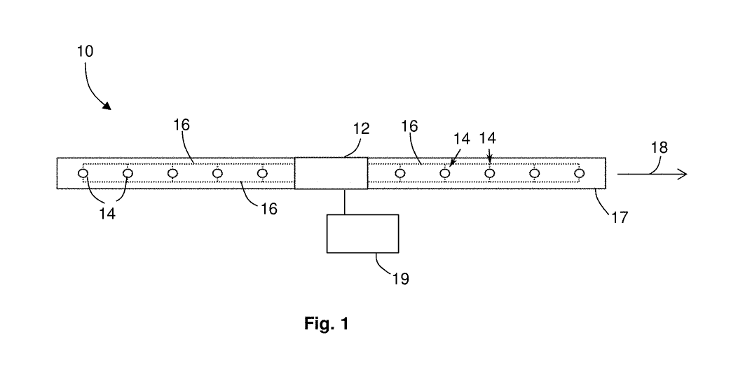

FIG. 1 is a schematic illustration of a luminaire system comprising a luminaire 10 in accordance with an embodiment. Luminaire 10 is illustrated as if viewed from below, for example as if viewed from the floor under a ceiling on which the luminaire 10 is mounted.

The luminaire 10 is configured for use in a LiFi system in which data is transmitted using visible light communication (VLC). In other embodiments, the luminaire 10 may be configured for use in any optical wireless communication system, which may or may not use visible light for data transmission. For example, the luminaire 10 may be configured to transmit data using infrared light or ultraviolet light. The luminaire 10 may be configured to transmit data using a wavelength between 450 nm and 850 nm.

Luminaire 10 comprises a driver apparatus 12 (which may be referred to as a LiFi enabled LED drive head), a plurality of LEDs 14 and a plurality of wires 16. In the embodiment of FIG. 1, the driver apparatus 12, LEDs 14 and wires 16 are contained within a housing 17. The housing 17 is similar in shape and size to the housing of a conventional striplight, for example a fluorescent striplight. For example, the housing 17 may have a length of 1300 mm, a width of 100 mm and a height of 100 mm. In some embodiments, the height of the housing 17 may be less than the height of a housing of a fluorescent striplight. In further embodiments, any size and shape of housing may be used.

The LEDs 14 are arranged along a longitudinal axis 18 of the housing 17. Each of the LEDs 14 is positioned at a respective predetermined position on the longitudinal axis 18 of the housing 17, such that the LEDs 14 are distributed along the length of the luminaire 10. For example, the LEDs 14 may be placed at equal intervals along the longitudinal axis 18. In some embodiments, the positioning of the driver apparatus 12 may affect how the LEDs are distributed. In some embodiments, the driver apparatus 12 is positioned behind the LEDs.

In other embodiments, the LEDs 14 may have different predetermined positions on the luminaire. Any suitable positioning of the LEDs in one, two or three dimensions may be used.

Each of the plurality of LEDs 14 is configured to emit visible light, for example white light. For simplicity, we refer to individual LEDs 14 in the description below, the individual LEDs 14 being spaced at intervals along the longitudinal axis 18. However, in practice, each LED light 14 represented by a circle in FIG. 1 may comprise a plurality of white or coloured LEDs. For example, each LED light 14 may comprise red, green and blue LEDs. In further embodiments, the LEDs 14 may be supplemented or replaced by any suitable light sources, for example lasers, laser diodes, or LEPs.

In the present embodiment, driver apparatus 12 is positioned in a central position with respect to the longitudinal axis 18, such that the arrangement of LEDs 14 on one side of the driver apparatus 12 is a mirror image of the arrangement of LEDs 14 on the other side of the driver apparatus 12. In other embodiments, the driver apparatus 12 may be positioned in any position on the longitudinal axis 18 in which it has LEDs 14 on both sides. Each of the LEDs may be considered to be remote from the driver apparatus 12.

The driver apparatus 12 may comprise components including, for example, a data input terminal, a control interface, a digital to analog converter, an adjustable gain/attenuation component, a voltage to current amplifier, and an LED output terminal (not shown).

The LEDs 14 are connected to the driver apparatus 12 by the wires 16. The driver apparatus 12 is configured to drive each of the plurality of LEDs 14 to produce modulated light by transmitting a driving signal on the wires 16.

In use, the driver apparatus 12 receives a data signal from a LiFi unit 19. In the present embodiment, the LiFi unit 19 is external to the luminaire 10. In other embodiments, the LiFi unit 19 may be positioned within the luminaire 10. The LiFi unit 19 may be integrated into the driving apparatus 12.

The LiFi unit 19 is a signal generating apparatus that is configured to receive input data (for example, Ethernet data) via a wired or wireless network connector, and to convert that input data into the data signal that is sent to the driver apparatus 12. The LiFi unit 19 may act as a network bridge, or router. It may contain buffers for incoming data and translate between the protocols used on LiFi and network. It may also handle multiple access and provide infrastructure for roaming. The LiFi unit 19 may be configured to encapsulate and/or reframe data in a format suitable for a LiFi protocol; to perform error detection and correction; to perform data retransmission if necessary; and/or to perform data encryption and/or decryption.

The data signal received by the driver apparatus 12 from the LiFi unit 19 is an electrical signal that is modulated to represent data, for example data that forms part of or at least partially corresponds to the input data received by the LiFi unit 19. The data signal may be analog or digital. In the present embodiment, the data signal is modulated using on-off keying. In other embodiments, any suitable modulation scheme may be used, for example quadrature amplitude modulation, phase shift keying, orthogonal frequency division multiplex, amplitude modulation, or frequency modulation.

The data signal may comprise a simple representation of a desired LED brightness in real time. The driver apparatus 12 translates the data signal into an LED current for driving the LEDs. For example, the driver apparatus 12 may amplify the data signal. The LED current may be referred to as a driving signal. In the present embodiment, the driving signal is modulated using on-off keying. In other embodiments, any suitable modulation scheme may be used, for example quadrature amplitude modulation, phase shift keying, orthogonal frequency division multiplex, amplitude modulation, or frequency modulation.

The LED current travels down the wires 16 to the LEDs 14 and modulates the LED brightness. In the present embodiment, an average LED current is 500 mA, with 200 mA and 1 A being the extremes during modulation. LED brightness is approximately linear with current.

The driving signal may produce an LED brightness that is linear with a value of the data signal. For example, the brightness may vary linearly with a voltage of the data signal in the case of analog signals, or with a numerical value of the data signal in the case of digital signals.

The LEDs 14 are modulated at a rate such that the modulating of the LEDs 14 is invisible to the human eye. The modulating of the LEDs 14 transmits data at a high data rate. In the present embodiment, a data rate of transmission by the LEDs 14 is of the order of Mbps. In other embodiments, a data rate of transmission may be of the order of Gbps.

In the present embodiment, the driver apparatus 12 drives all of the LEDs 14 to produce the same modulation, and therefore all of the LEDs 14 transmit the same OWC signal. In other embodiments, the driver apparatus may drive different LEDs 14 or sets of LEDs 14 to transmit different OWC signals. For example, LEDs 14 at one end of the luminaire may transmit a different OWC signal from LEDs 14 at the other end of the luminaire. The different OWC signals may comprise or represent different data.

The luminaire 10 may be used as part of a striplight system. The luminaire 10 may be used as part of a more general lighting system which is LiFi enabled.

Data that is transmitted by the luminaire using modulated visible light from the LEDs 14 may be received by a remote receiver (not shown) comprising a photosensor and circuitry configured to decode the transmitted data.

For example, in one embodiment the luminaire 10 of FIG. 1 is mounted on the ceiling of an office and acts as an overhead striplight. The overhead striplight is driven to stream high-speed data. The light from the overhead striplight is received by a receiver embedded in a receiver dongle, which is positioned below the luminaire 10. The receiver comprises at least one light detector, for example at least one photodiode. The receiver converts the light received by the at least one light detector back into a data signal which is then provided to a computer apparatus, for example a PC.

The use of modulated light may allow secure wireless transmission of high speed data. The data transmission may be restricted to a single room, since light cannot pass through walls. Data transmission may be localised to particular areas within a room. For example, different luminaires or parts of luminaires may transmit different data.

To obtain a desired performance of an LED 14 being modulated for LiFi, the LED driver apparatus 12 may be placed as close to the LEDs as possible. This may reduce (for example, minimise) driver impedance, which may improve (for example, maximise) bandwidth.

In the embodiment of FIG. 1, the driver apparatus 12 is placed in the middle of a line of LEDs 14. The driver apparatus 12 is positioned at the centre of the lamp. The configuration of the LED driver head 12 and individual LED lamps 14 may reduce the distance between the LiFi enabled LED driver 12 and the individual LEDs, for example when compared to an arrangement in which a driver apparatus 12 were to be positioned at the end of the line of LEDs. By reducing the distance between the LED driver 12 and the individual LEDs 14, the length of the wires 16 may be reduced, and the bandwidth of the system may therefore be improved.

In other embodiments, the driver apparatus 12 may be placed anywhere within the line of LEDs. In further embodiments, the driver apparatus 12 may be placed in any location such that LEDs 14 are present on two opposing sides of the driver apparatus 12. For example, the driver apparatus 12 may be placed within a two-dimensional array of LEDs 14 in a lighting panel.

The placement of the driver apparatus 12 and LEDs 14 may reduce (for example, minimise) a length of wires 16 used to connect the LEDs 12 to the driver apparatus 12. A maximum length of wire that connects any of the LEDs 14 to the driver apparatus 12 may be minimised. In some circumstances, a maximum length of wire that connects any of the LEDs 14 to the driver apparatus 12 may be approximately halved when compared to a scenario in which the driver apparatus 12 were positioned at one end of the line of LEDs 14. By reducing a length of wire, parasitic induction in the wire may be reduced. By reducing a length of wire, electromagnetic interference (EMI) and/or RF emissions may be reduced.

The luminaire 10 of FIG. 1 may provide an LED striplight that is suitable for use as a LiFi enabled luminaire. The configuration of the luminaire 10 may be considered to provide a method of configuring a lighting module to resemble a conventional striplight, for example a fluorescent striplight.

FIG. 1 shows a luminaire 10 in which one line of LEDs 14 is arranged along an axis 18. In other embodiments, multiple lines of LEDs 14 may be used, for example multiple parallel lines. In further embodiments, any shape of luminaire may be used. For example, the housing of the luminaire may be square or circular. The luminaire may be a panel light, and LEDs 14 may be arranged in two dimensions on a downward-pointing surface of the panel light. Any arrangement of LEDs 14 in one, two or three dimensions may be used. The driver apparatus 12 may be positioned such as to reduce (for example, minimise) a length of wire between each of the LEDs 14 and the driver apparatus 12, for example by placing the driver apparatus at or near the centre of the luminaire 12.

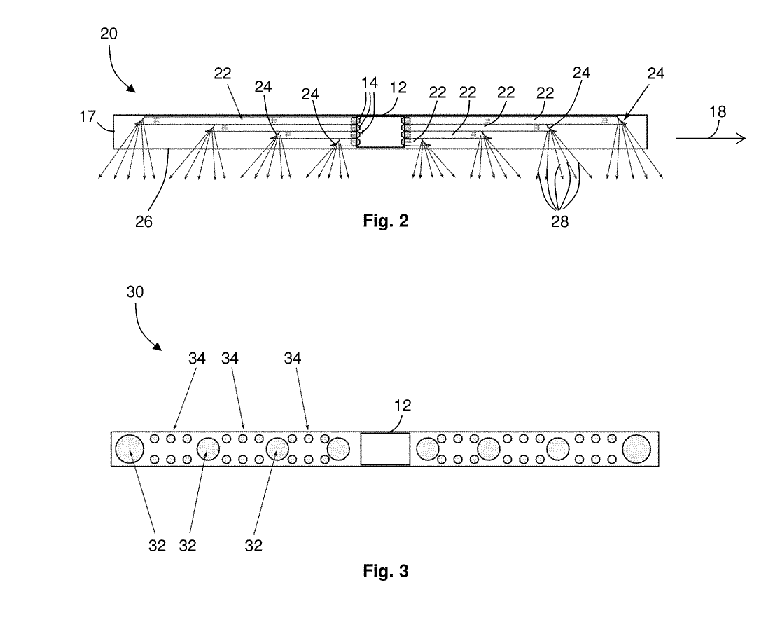

FIG. 2 is a schematic illustration of a luminaire system comprising a luminaire 20 in accordance with a further embodiment. The luminaire 20 is illustrated as if viewed from the side.

The luminaire 20 is configured for use in a LiFi system in which data is transmitted using visible light communication (VLC). In other embodiments, the luminaire may be configured for use in any optical wireless communication system, which may or may not use visible light for data transmission.

Luminaire 20 comprises a driver apparatus 12 and a plurality of LEDs 14. In the present embodiment, the driver apparatus 12 and LEDs 14 are positioned at or near the centre of luminaire 20. The LEDs 14 are connected to the driver apparatus 12, for example by a plurality of wires (not shown) or by direct connectors (not shown). The LEDs 14 in combination with the driver apparatus 12 and a LiFi unit (not shown) may be considered to provide a LiFi enabled LED drive head that is configured to provide modulated LED light. The LiFi unit may be internal or external to the luminaire 20. The LiFi unit may be integrated with the driver apparatus 12.

Each of the plurality of LEDs 14 is configured to emit modulated visible light when driven by a driving current from the driver apparatus 12, as described above with reference to FIG. 1. Although individual LEDs 14 are shown in FIG. 2, in other embodiments each of those LEDs 14 may be replaced by multiple white or coloured LEDs, for example by red, green and blue LEDs.

Luminaire 20 further comprises a plurality of fibre bundles 22 and a plurality of convex mirrors 24. Each fibre bundle 22 is configured to guide light from a respective one of the LEDs 14 to a respective one of the convex mirrors 24. The convex mirrors 24 are spaced along a longitudinal axis 18 of the luminaire 20 so as to output light from a plurality of predetermined locations that are remote from the driver apparatus 12 and LEDs 14. In the present embodiment, the LED head is positioned in the centre of the luminaire and the fibre bundles 22 and convex mirrors 24 are distributed along the axis 18 such that they are symmetrically distributed in relation to the LED head.

The driver apparatus 12, LEDs 14, fibre bundles 22 and convex mirrors 24 are housed in a housing 17.

In use, the driver apparatus 12 receives a data signal from the LiFi unit (not shown). The driver apparatus 12 drives the LEDs 14 in dependence on the data signal to produce modulated light.

Modulated light from each LED 14 travels down the fibre bundle 22 that is coupled to that LED 14 and is reflected from the convex mirror 24 at the end of the fibre bundle 22, so as to be output from the fibre bundle 22. The fibre bundle 22 and convex mirror 24 may be considered to form a light guide, the light guide having an output at the convex mirror 24. The convex mirror 24 may shape the light such that it is emitted over a desired range of angles.

Light from the output of each light guide is emitted through a bottom face 26 of the housing 17 of the luminaire. Arrows 28 on FIG. 2 indicate paths that light takes through the bottom face 26. The light emitted from each light guide output passes through a respective light emission region of the bottom face 26.

The outputs of the light guides are distributed in predetermined locations along the longitudinal axis 18 of the luminaire 20. The way that light is emitted from the outputs may make the luminaire 20 resemble a conventional LED or fluorescent striplight.

In other embodiments, outputs may be distributed over the luminaire in any suitable manner. The outputs may have any suitable spacings. In some embodiments, the outputs may be contiguous. The luminaire itself may have any suitable form factor, which may or may not resemble a conventional striplight. In one embodiment, the luminaire is a panel light, the light guides comprise optical fibres, and downwards-pointing, or otherwise suitably arranged, outputs of the optical fibres are distributed across a surface of the panel light.

In other embodiments, any suitable guide or guides may be used to guide light from the light sources. For example, the fibre bundles 22 may be replaced or supplemented by any suitable light guiding elements, for example by light pipes or hollow fibres. The convex mirrors 24 may be replaced or supplemented by any suitable optical components. The guides may comprise any suitable optics. In some embodiments, different light guides may be used to guide different colours of light.

In the present embodiment, each LED 14 is coupled to a respective guide 22, 24. In some embodiments, multiple LEDs may couple to each guide, or multiple guides may be coupled to each light source. Any suitable type of light source may be used, for example LED, laser, laser diode, or LEP. Any number of light sources may be used. Light sources of different colours may be used. In some embodiments, a single light source may be used and light from the single light source may be transmitted through one or more light guides.

In the embodiment of FIG. 2, each guide has a respective output. In other embodiments, a guide may have multiple outputs. For example, outputs may be provided along the length of a guide.

The arrangement of FIG. 2 may further reduce the drive cable length (i.e. the length of any wires connecting the LEDs 14 to the driver apparatus 12), since the LEDs 14 are not positioned along the length of the striplight. The light guides may be positioned so as to output light at any desired output positions. Modulated light that is generated at a single location, for example a central location, may be emitted from a plurality of remote outputs.

By using a system of light pipes, fibre bundles or other suitable optical elements, light may be transmitted from an LED head to a system of custom mirrors, lenses or any other form of suitable optical elements. The mirrors may be designed to create desired illumination areas.

The description of FIG. 2 above may describe a method of configuring a lighting module to at least partially replicate a conventional striplight. A LED striplight may be provided that provides illumination similar to that of a conventional striplight, while also providing OWC communication, for example LiFi communication. Providing LiFi communication from overhead-mounted striplights may be an efficient way to implement LiFi in an office setting.

By distributing light over the plurality of outputs using a plurality of guides, the light may provide a suitable illumination profile without requiring a wired connection between a LiFi driver apparatus 12 and distant light sources. Instead, the light sources (in this embodiment, LEDs 14) are placed near to the driver apparatus 12, which may reduce signal degradation, improve bandwidth and/or reduce electromagnetic interference.

The use of guides may allow the LiFi driver apparatus 12 to be placed at any appropriate location in the luminaire 10. In the present embodiment, the driver apparatus 12 and light sources 14 are positioned centrally. In other embodiments, any appropriate positioning of the driver apparatus 12 and/or light sources 14 may be used. For example, the driver apparatus 12 and light sources 14 may be placed at an end of the luminaire and the guides may guide light along the length of the luminaire to a plurality of remote outputs arranged at predetermined locations along the luminaire.

In some embodiments, the luminaire may comprise a plurality of driving apparatuses, each configured to drive a respective one or more light sources. Light sources may be placed at a plurality of locations, and light may be guided from each light source location by a respective one or more guides.

FIG. 2 is described above with reference to the transmission of modulated light. In other embodiments the system of FIG. 2 may be used to receive modulated light, for example light that is modulated to transmit uplink data from a dongle attached to a PC.

In some embodiments, the system of FIG. 2 comprises a receiver (not shown), which may be co-located with or positioned in proximity to the driving apparatus 12 and/or an integrated LiFi unit. The receiver comprises at least one detector configured to detect modulated light.

Modulated light (for example, light modulated to transmit an uplink signal) is received at the surface 26 and is guided to the receiver by the guides 22, 24. The received light therefore follows the same optical path (although in the opposite direction) as modulated light that is transmitted by the LEDs 14. In other embodiments, any suitable receiver configuration may be used. Received light may at least partially follow the same optical path as transmitted light.

In some embodiments, the receiver comprises a respective detector for each of the guides. In other embodiments, one detector may receive light from two or more of the guides. The or each detector converts the received light into electrical signals. Signals from multiple detectors may be summed by the receiver. The resulting signals from the receiver may be processed by the or a LiFi unit.

FIG. 3 is a schematic illustration of a luminaire system comprising a luminaire 30 in accordance with an embodiment. Luminaire 30 is illustrated as if viewed from below.

In the embodiment of FIG. 3, modulated light from LEDs 14 (not shown in FIG. 3) is used to provide LiFi over a range of angles, while further light sources 34 are used to provide illumination over a greater range of angles than the range for which LiFi is provided.

Conventional striplighting may typically provide an illumination angle of around 180 degrees. This gives a very large area of even illumination. However, LiFi enabled lighting may offer a much higher data density if the lighting fixtures have a smaller illumination angle. One or more optical atto cells may be created, each cell offering a secure isolated LiFi connection. Atto cells may be created that have variable shape. For example, atto cells may be configured at installation. A central LiFi transmitter may be combined with remote lighting heads which may be positioned anywhere. Each luminaire may be configured to give optimum coverage for a seating/desk area below. The lighting may be configured to suit a seating pattern.

The embodiment of FIG. 3 addresses the data density issue by emitting LiFi signals over a smaller range of angles than the total range of angles that are illuminated by the luminaire 30.

Luminaire 30 comprises the same driver apparatus 12, LEDs 14 (not shown in FIG. 3), light conduits 22 (not shown in FIG. 3) and convex mirrors 24 (not shown in FIG. 3) as the embodiment of FIG. 2. Light from the LEDs 14 passes through the light conduits 22 and convex mirrors 24 and is emitted at a plurality of outputs 32 which are indicated by circles on FIG. 3.

Luminaire 30 further comprises a plurality of further LEDs 34. Each of the further LEDs is non-LiFi enabled. Light from the further LEDs is not modulated for transmission of data. In some embodiments, light from the further LEDs may be modulated for dimming. The light from the further LEDs may be dimmed by pulse width modulation at a low modulation frequency, for example at a modulation frequency between 80 Hz and 100 Hz.

The further LEDs 34 may be driven by a further LED driver apparatus (not shown) or may be driven by the driver apparatus 12 in such a way that they do not transmit data, for example LiFi data. There may be one driver apparatus per luminaire.

In the embodiment of FIG. 3, the convex mirrors 24 are configured to provide light from LEDs 14 over a smaller angle of illumination than a typical striplight. For example, the convex mirrors may be configured to provide light over an angle of illumination that is less than 90 degrees, optionally less than 60 degrees. The convex mirrors 24 are configured to create illumination areas that may be relatively small in size compared to a total illumination area of the luminaire 30.

The further LEDs 34 are configured to provide light over angular regions that are not illuminated, or are not adequately illuminated, by light from the LiFi-enabled LEDs 14. For example, the further LEDs 34 provide sideways illumination. The further LEDs provide illumination over a wider angular range than that of the LiFi-enabled LEDs 14.

In the embodiment of FIG. 3, the further LEDs are positioned near the perimeter of the luminaire 30. When viewed from below, the outputs 32 occupy a central region of the luminaire 30, and the further LEDs 34 occupy a peripheral region of the luminaire 30.

In other embodiments, any arrangement of outputs 32 and further LEDs 34 may be used. For example, the further LEDs 34 may be interspersed between the outputs 32.

In the present embodiment, the further LEDs 34 are arranged at or near the surface of the luminaire and light from the further LEDs 34 is emitted at the locations of the further LEDs 34. In further embodiments, light from the further LEDs 34 may be guided to the outputs 32 , or to further outputs, by guides. The guides that guide light from the further LEDs 34 may or may not comprise the same guides 22, 24 that guide light from the LEDs 14.

The use of further LEDs 34 may improve peripheral illumination. The use of further LEDs 34 may better replicate the illumination of a conventional striplight, for example a fluorescent striplight or an existing LED striplight. The luminaire 30 may provide illumination similar to that of a conventional striplight, while providing LiFi coverage over a more limited area than the area that is illuminated.

By adding further LEDs 34 as well as the LiFi-enabled LEDs 14, the illumination pattern provided by the luminaire 30 may be extended to the side. The illumination pattern provided by the luminaire 30 may be extended to areas which are to be provided with illumination, but not LiFi coverage. A smaller LiFi cell size may be retained while still giving wide illumination.

In the embodiments of FIGS. 2 and 3 above, modulated light is provided by LEDs 14 which are driven by driver apparatus 12.

In other embodiments, any suitable light source may be driven by driver apparatus 12. In further embodiments, any suitable source of radiation may be driven by driver apparatus 12. The source of radiation may comprise a source of particles, for example electrons. Modulated radiation (for example, light or electrons) emitted by the source of radiation may be converted into modulated light by a light-emitting substance or device.

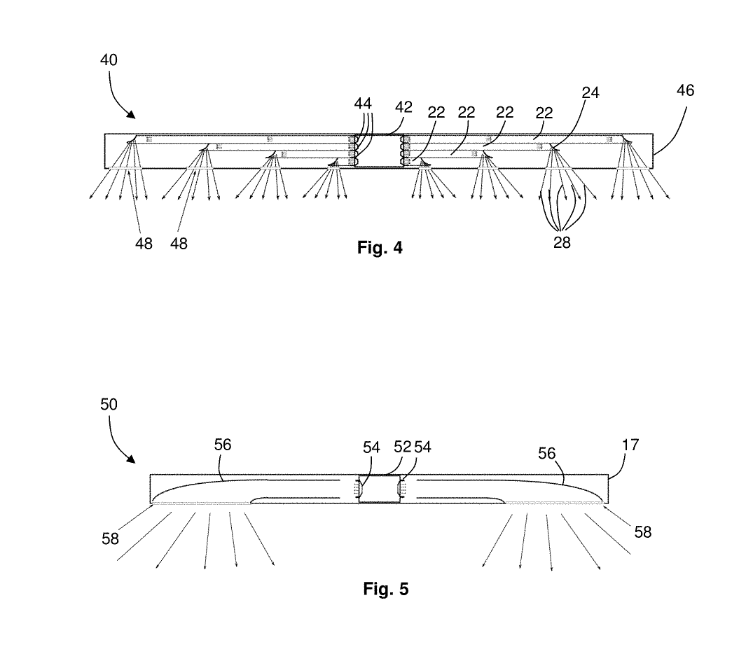

FIG. 4 is a schematic illustration of a luminaire system comprising a luminaire 40 in which the driver apparatus comprises a laser LiFi enabled driver 42. In the embodiment of FIG. 4, the luminaire 40 is a striplight. In other embodiments, the luminaire may have any suitable form factor.

Luminaire 40 comprises the driver apparatus 42, a plurality of lasers 44, a plurality of fibre bundles 22, a plurality of convex mirrors 24, and a housing 46. The housing 46 comprises a plurality of phosphor areas 48. Each phosphor area 48 comprises a light-emitting phosphor which is applied to a region of the housing 46.

The driver apparatus 42 and lasers 44 may together be considered to form a laser head, which replaces the LED head of the embodiment of FIG. 2. In some circumstances, lasers may be capable of a much higher bandwidth than LEDs for data transfer.

The driver apparatus 42 drives the lasers 44 to produce modulated light. To guide the modulated light, the embodiment of FIG. 4 uses the same guides as the embodiment of FIG. 2. In order to provide illumination, light from the lasers 44 is directed by the fibre bundles 22 and convex mirrors 24 onto the phosphor areas 48 on the striplight assembly. Arrows 28 indicate paths of light emitted from the outputs of the guides 22, 24 and passing through the phosphor areas 48. In other embodiments any suitable light guides may be used, for example light guides comprising light pipes.

The phosphor areas 48 act as outputs. The phosphor areas 48 receive the light from the lasers 44 (which may be of any appropriate range of wavelengths). In the present embodiment, the lasers 44 are blue lasers emitting light in the range of 360 nm to 480 nm. The phosphor areas 48 comprise a yellow phosphor. The yellow phosphor in the phosphor areas 48 is energised by the blue laser light and radiates white light for illumination. In other embodiments, different colours of laser and/or phosphor may be used.

Since the light produced by the lasers 44 is modulated to comprise or represent a LiFi signal, the light produced by the phosphor areas 48 in response to the light from the lasers 44 is also modulated to comprise or represent the LiFi signal.

Although in the present embodiment the phosphor areas 48 comprise a phosphor configured to emit white light, in other embodiments any suitable light-emitting substance or device may be used to emit any desired colour or colours of light. Any suitable photoluminescent material may be used. In some embodiments, the light-emitting substance comprises quantum dots. The light emitted may be visible, infrared, or ultraviolet.

By using the phosphor areas 48 to convert light into white light, it may be possible to use light sources (in this embodiments, lasers 44) that do not have the same spectrum as the light that is to be emitted from the luminaire 40. For example, light from the lasers may have a narrower bandwidth than the light to be emitted. Therefore, types of light source may be used that would not be appropriate if emitting the light source directly.

In the present embodiment, all of the lasers 44 emit the same spectrum of light. The phosphor areas 48 convert the light spectrum of the lasers 44 into a desired light spectrum, for example a white light spectrum.

In other embodiments, the lasers 44 or alternative light sources may be configured to emit light of more than one colour. For example, in one embodiment, the LEDs 14 of FIG. 2 are replaced by LEDs of multiple different colours.

Light from the LEDs, lasers or other optical emitters may be directed to an optical system or assembly that mixes the different colours appropriately in order to generate light with an appropriate colour profile suitable for illumination. The optical system or assembly may be referred to as a mixer. The optical system or assembly may be configured to emit light over a desired range of emission angles.

In some embodiments, the optical system or assembly always produces light of a single desired spectrum, for example white light. In other embodiments, the optical system or assembly may be programmable so as to emit light of more than one spectrum. For example, the optical system or assembly may be configured to change a colour of the emitted light in response to a control signal.

In further embodiments, any suitable system, assembly or substance may be used to change the colour of the emitted light.

FIG. 5 is a schematic illustration of a luminaire system comprising a luminaire 50 in which a driver apparatus 52 is configured to drive electron sources 54 to emit a modulated beam of electrons. In other embodiments, any suitable source may be used to emit a beam of any suitable particles. The driver apparatus 52 and electron sources 54 may be considered to provide an electron head.

In addition to the driver apparatus 52 and electron sources 54, the luminaire 50 comprises deflection plates 56 that are positioned on either side of the electron head and configured to deflect electrons emitted by the electron head downwards towards phosphor coated regions 58 of a housing 17 of the luminaire 50. The deflection plates 56 act as guides. The phosphor coated regions 58 act as outputs.

In use, a beam of electrons is emitted from either side of the electron head. The beams are deflected by the deflection plates 56 to strike the phosphor coated regions 58 on the striplight. The phosphor areas 58 are energised by the electron beams and emit white (or other suitable colour) light for illumination.

Providing phosphor areas 58 to convert electrons into light allows the use of an electron source rather than a light source. Electron-stimulated luminescence (ESL) may be used. The use of an electron source may result the emission of light having a wide bandwidth, for example a bandwidth that is wider than that generated by an LED or laser.

Further light sources that are not modulated to transmit LiFi data may be added to the embodiments of FIG. 4 or FIG. 5, for example to provide illumination in regions that are not covered by LiFi. In some embodiments, LiFi is transmitted over a limited range of wavelengths while the further light sources provide illumination over a wider range of wavelengths. For example, LiFi may be transmitted at red wavelengths while the further light sources provide green and blue wavelengths.

In each of the embodiments of FIGS. 1 to 5, the luminaire 10, 20, 30, 40, 50 is a striplight. The striplight may provide wide-angle illumination that may be similar to the illumination provided by a conventional (non-LiFi enabled) LED or fluorescent striplight.

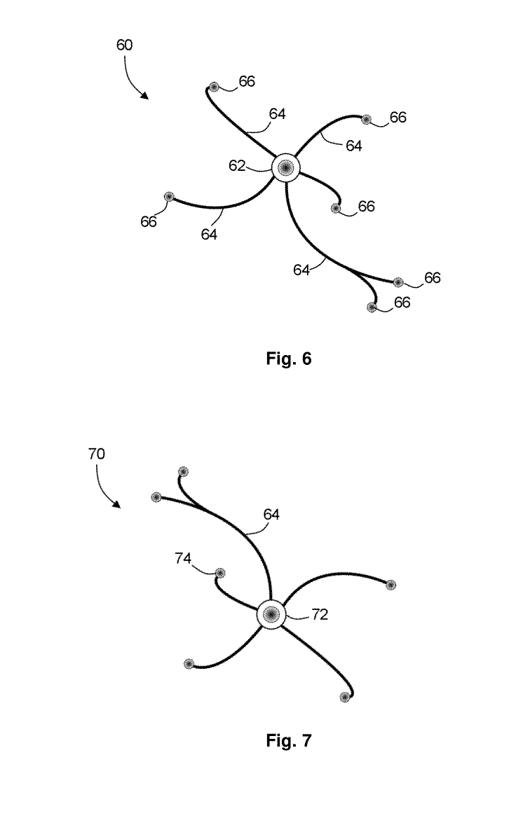

In other embodiments, the luminaire may have any suitable form factor. In some scenarios, a user may want to create a custom lighting footprint. FIGS. 6 and 7 show lighting arrangements achieved by a variation of fibre bundles and a LiFi enabled driver head, for example a variation of the arrangement shown in FIG. 2 in which fibre bundles 22 are used to guide light from a plurality of LEDs 14 to a plurality of outputs.

FIG. 6 is a schematic illustration of a luminaire system 60, shown as viewed from below. Luminaire system 60 comprises a LiFi LED unit 62, which may be a single channel or multi-channel LiFi LED unit.

In the present embodiment, the LiFi LED unit 62 comprises an LED driver, a plurality of LEDs and a LiFi unit. The LED driver is configured to drive the LEDs to provide modulated light in dependence on a data signal from the LiFi unit.

Luminaire 60 further comprises a plurality of flexible fibre bundles 64 configured to guide light from the LiFi LED unit 62 to a plurality of light emitting units 66, each comprising a respective housing and a respective reflector. The light emitting units 66 may be referred to as lighting heads. The light emitting units 66 are remote from the LiFi LED unit 62.

In use, the LiFi LED unit 62 produces modulated light which is guided to the lighting head 66 by the fibre bundles 64. In each lighting head 66, the reflector reflects light downwards over a desired angular range.

The flexibility of the fibre bundles 64 allows the fibre bundles 64 and lighting heads 66 to be positioned in many different configurations. In the embodiment of FIG. 6, the fibre bundles 64 are curved in such a way that they may be considered to be aesthetically pleasing. Different lighting heads 66 are placed at different distances from the LiFi LED unit 62. The lighting heads 66 may be spaced or grouped together as desired. For example, in FIG. 6, two of the lighting heads 66 are closely spaced, with their respective fibre bundles being grouped together for part of their length. In other embodiments, the lighting heads 66 may be differently arranged.

A flexible lighting layout may be provided. For example, if the luminaire 60 is mounted on a ceiling, each lighting head 66 may be positioned at any desired location on that ceiling. The lighting heads 66 may not be regularly spaced. In some circumstances, the lighting heads 66 may be placed above parts of a room for which LiFi illumination is required, for example above desks or workstations. An atto cell may be provided that may be configured to suit a specific seating arrangement. Remote lighting heads 66 may be positioned anywhere.

In some embodiments, the LiFi LED unit 62 is positioned at a location of an existing power and/or data connection, and provides light to locations that do not have any existing power and/or data connection. The lighting provided by the luminaire 60 may be more easily configurable than some existing lighting systems. Areas of LiFi illumination may be provided as desired.

Several LiFi-enabled lighting areas may be provided with light from a single LiFi LED unit 62. By transmitting modulated light along fibre bundles (or other light conduits) to remote lighting heads, signal degradation may be reduced when compared to a system that instead sends an electrical driving signal along wires to remote lighting heads.

The embodiment of FIG. 6 may be considered to be a variation of the embodiment of FIG. 2 which is used to make a very flexible lighting system by using positionable light emitting units coupled to the LiFi LED unit by flexible light conduits.

FIG. 7 is a schematic illustration of a luminaire system 70, shown as viewed from below. Luminaire system 70 comprises a laser LiFi unit 72, which may be a single channel or multi-channel laser LiFi unit. The laser LiFi unit 74 comprises a laser driver apparatus, a one or more lasers and a LiFi unit. The laser driver is configured to drive the LEDs to provide modulated light in dependence on a data signal from the LiFi unit.

Luminaire 70 further comprises a plurality of fibre bundles 64 and a plurality of phosphor coated lighting heads 74, each comprising a phosphor region.

In use, the laser LiFi unit 72 produces modulated light which is guided to the lighting heads 74 by the fibre bundles 64. In each lighting head 74, the phosphor region converts the laser light into light of a desired spectrum, for example white light.

If the laser LiFi unit 72 is a single channel laser LiFi unit, the laser LiFi unit 72 may be configured to send the same modulated light to all of the lighting heads 74. If the laser LiFi unit 72 is a multiple channel laser LiFi unit, the laser LiFi unit 72 may be configured to send different modulated light to different ones of the lighting heads 74. For example, modulated light comprising or representing different LiFi data may be sent to different ones of the lighting heads 74.

The lighting heads 74 may further comprise optical components (for example, mirrors or lenses) configured to shape the light emitted by the lighting heads 74. The lighting heads 74 may further comprise additional light sources that are not modulated to transmit LiFi data.

The embodiments of FIG. 6 and FIG. 7 have configurations which have a central LiFi enabled LED unit 62, 72 with flexible fibre bundles 64, 74 to transmit light to remote lighting heads 66, 76. In this way a user may have more flexibility to customise a lighting footprint to suit their requirements.

Techniques have been described for creating a striplight system and a more general lighting system which is LiFi enabled. A striplight may be created that is suitable for use as a LiFi enabled luminaire. Alternatively, any suitable shape of LiFi enabled luminaire may be created, for example a panel light or spotlight.

In the above embodiments, the luminaire is ceiling-mounted. In other embodiments, the luminaire may be mounted on a wall or on a stand, or may comprise or form part of a portable device.

A LiFi enabled luminaire may comprise, for example, an LED luminaire (for example, as described with reference to FIG. 1, 2, 3 or 6, a laser luminaire (for example, as described with reference to FIG. 4 or 7) or an electron luminaire (for example, as described with reference to FIG. 5).

Any one of the luminaire systems described above with reference to FIGS. 1 to 7 may further comprise one or more receivers configured to receive modulated light, for example, modulated infrared light that is used to transmit a LiFi uplink signal.

Detector elements (for example, photodiodes, photomultipliers, imaging sensors etc.) and/or receiver optics coupled to optical waveguides may be integrated into the overall design of the luminaire system. The integration of detector elements and/or receiver optics may lead to the design of an integrated panel or striplight system that is fully capable of bidirectional optical wireless communication and may serve the purpose of an access point in a network configuration. In some embodiments, detectors are distributed over the entire area of a luminaire and received information signals (in optical or electrical form) are guided to a common processing unit that implements all the signal processing steps for communication. The common processing unit may be a LiFi unit.

By distributing receivers over the luminaire, for example along the length of the striplight, signal reception may be improved. In particular, it may be possible to obtain good signal reception even when it is not known in advance where the device transmitting the received signal is to be placed in relation to the luminaire. Better coverage may be obtained by using multiple receivers.

The embodiments described above with reference to FIGS. 1 to 7 are each configured to provide visible lighting, for example ceiling-mounted striplighting.

In other embodiments, OWC data is transmitted using light that is not visible. For example, concepts presented above may be used for the creation of an infrared optical transmission, where techniques described above may be used for generation of a suitable emission profile that may provide high-power uniform illumination that meets eye-safety constraints. In any of the embodiments described above, visible light sources may be replaced or supplemented by IR sources.

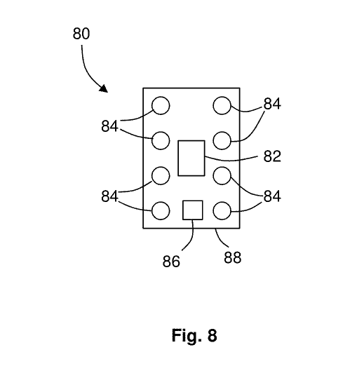

FIG. 8 is a schematic illustration of a portable, for example hand-held, luminaire 80 that is configured to emit infrared light. The infrared luminaire 80 is configured to receive LiFi downlink data via visible light from a ceiling-mounted luminaire, for example the luminaire of any of FIGS. 1 to 7, and to transmit LiFi uplink data by transmitting modulated infrared light.

The structure of infrared luminaire 80 may be considered to be similar to that of luminaire 20 of FIG. 2, but on a smaller scale, and with a different transmission band.

Infrared luminaire 80 comprises an infrared LED LiFi unit 82 which comprises an LED driver, a plurality of infrared LEDs and a LiFi unit. The LED driver is configured to drive the infrared LEDs to emit modulated infrared light in dependence on a data signal from the LiFi unit.

The LEDs are coupled to a plurality of guides (for example, light pipes or fibre bundles) which are configured to guide modulated infrared light from the LEDs towards a plurality of outputs 84 at which the modulated infrared light is emitted.

The infrared luminaire 80 further comprises a receiver 86 that is configured to receive modulated visible light, and a housing 88 that houses the infrared LED LiFi unit 82, the guides, and the receiver 86.

In use, modulated infrared light from the LEDs of the infrared LED LiFi unit 82 is guided to the outputs 84 for emission. In the present embodiment, the outputs 84 are distributed across a planar surface of the infrared luminaire 80 to form a light panel. Light from the LEDs is therefore distributed in space.

By distributing the infrared light from the LEDs across a plurality of outputs, the intensity of the infrared light may be lower than if all the infrared light were to be emitted at a single output. The distribution of the infrared light may be such as to conform with eye safety regulations, for example regulations that restrict the amount of infrared light that may be emitted from a given area.

The infrared luminaire 80 may provide an infrared emitter where the radiation is distributed such that the emitted satisfies a set of emission requirements and/or constraints related to coverage, emission profile, eye safety, etc.

In some embodiments, the infrared luminaire 80 is a similar size to, or smaller than, a mobile device such as a mobile phone. In some embodiments, the infrared luminaire 80 comprises or forms part of a dongle.

In some embodiments, the infrared luminaire 80 may produce a lower light level than a visible light luminaire, for example a visible light luminaire as described above with relation to FIGS. 1 to 7. The infrared luminaire 80 may produce, for example, 150 mW total radiant flux. The infrared spectrum produced by the infrared luminaire 80 may be narrower than the white light illumination produced by a visible light luminaire.

Although embodiments described above transmit data using LiFi, in other embodiments any suitable method of optical wireless communications may be used to transmit data using light. The luminaire may be configured for any type of OWC.

Any suitable radiation source or sources may be used. In some embodiments, light from a single source is distributed across multiple outputs. In some embodiments, an output emits light from multiple light sources.

Certain embodiments have been described in which a driver apparatus and a plurality of light sources, or other radiation sources, are provided in a luminaire, for example within a single housing. In other embodiments, more than one driver apparatus is provided for a single luminaire, for example with one of the driver apparatuses driving operation of one or more of the light sources included in the luminaire to provide modulated radiation (e.g. light) comprising or representing an OWC signal and another of the driver apparatuses driving operation of at least one or more other of the light sources included in the luminaire to provide modulated radiation (e.g. light) comprising or representing an OWC signal. In some embodiments, more than one receiver is included in the or a luminaire, each receiver configured to receive light that is modulated to comprise or represent an OWC signal. The receivers may be configured to receiver or detect light at the same or different wavelengths and thus to receive or detect the same or different OWC signals.

Features of any of the above embodiments may be combined with features of any of the above embodiments. For example, features of the embodiment of FIG. 1 in which light sources are distributed along the luminaire may be combined with features of the embodiments of FIGS. 2 to 8 in which light is guided to a plurality of remote outputs. Features of the striplights described in relation to FIGS. 1 to 5 may be combined with features of the non-striplight embodiments of FIGS. 6 to 8.

It will be understood that the present invention has been described above purely by way of example, and modifications of detail can be made within the scope of the invention. Each feature disclosed in the description, and (where appropriate) the claims and drawings may be provided independently or in any appropriate combination.

1. An optical wireless communication (OWC) enabled luminaire system comprising:
at least one radiation source;
a driver apparatus configured to drive the at least one radiation source to produce modulated radiation comprising or representing an OWC signal;
a plurality of outputs configured to output modulated light that comprises or is generated using the modulated radiation produced by the at least one radiation source, wherein the plurality of outputs are positioned at substantially different locations that are remote from the at least one radiation source; and
at least one guide configured to guide the modulated radiation from the at least one radiation source to the plurality of outputs.

2. The luminaire system according to claim 1, wherein the number of the light outputs at substantially different locations is greater than the number of radiation sources, such that the modulated radiation comprising or representing an OWC signal is guided from the radiation source or one of the radiation sources to a plurality of the light outputs at substantially different locations.

3. The luminaire system according to claim 1, wherein each of the outputs is positioned at a respective predetermined location such that the outputs are distributed over a luminaire of the luminaire system.

4. The luminaire system according to claim 3, wherein the luminaire is a striplight, and the outputs are distributed along a length of the striplight.

5. The luminaire system according to claim 1, wherein the at least one radiation source comprises at least one light source configured to produce visible, infrared or ultraviolet light, and the modulated radiation produced by the at least one radiation source comprises modulated visible, infrared or ultraviolet light.

6. The luminaire system according to claim 1, further comprising at least one light-emitting substance or device configured to convert at least part of the modulated radiation produced by the at least one radiation source into the modulated light that is output from the plurality of outputs.

7. The luminaire system according to claim 1, wherein the at least one radiation source comprises an electron source, and the modulated radiation produced by the at least one radiation source comprises at least one beam of electrons.

8. The luminaire system according to claim 1, wherein the modulated light output from the plurality of outputs comprises at least one of visible light, white light, infrared light, ultraviolet light.

9. The luminaire system according to claim 1, further comprising at least one further light source configured to produce light that is not modulated to comprise or represent an OWC signal.

10. The luminaire system according to claim 9, wherein the outputs are configured to output modulated light over a first range of illumination angles, and the at least one further light source is configured to output light over a second, larger range of illumination angles.

11. The luminaire system according to claim 9, wherein the outputs are configured to output modulated light having a first wavelength or range of wavelengths, and the at least one further light source is configured to output light having a second, different wavelength or range of wavelengths.

12. The luminaire system according to claim 1, wherein the or each guide comprises at least one of: a light conduit, a fibre bundle, an optical pipe, an optical component, a mirror, a convex mirror, a lens, an electron deflector plate.

13. The luminaire system according to claim 1, further comprising a mixer configured to mix modulated light emitted at least one of by the at least one radiation source, by the at least one light-emitting substance or device, or by the at least one further light source to obtain light of a selected colour profile.

14. The luminaire system according to claim 1, further comprising a receiver configured to receive light that is modulated to comprise or represent a further OWC signal.

15. The luminaire system according to claim 14, wherein the at least one guide is further configured to guide received modulated light from the plurality of outputs to the receiver.

16. The luminaire system according to claim 1, comprising a luminaire that comprises the driver apparatus, at least one further driver apparatuses and a plurality of radiation sources, wherein each of the driver apparatuses and the at least one further driver apparatus is configured to drive a respective at least one of the radiation sources to produce modulated radiation comprising or representing an OWC signal or OWC signals.

17. The luminaire system according to claim 16, wherein the receiver is included in said luminaire.

18. The luminaire system according to claim 17, comprising at least one further receiver configured to receive light that is modulated to comprise or represent the or a further OWC signal, wherein the receiver and the at least one further receiver are both included in said luminaire.

19. The luminaire system according to claim 1, wherein a data transmission rate of at least one of the OWC signal, driving signal, or modulated light is at least 1 kbps, optionally at least 1 Mbps, further optionally at least 1 Gbps.

20. The luminaire system according to claim 1, wherein the OWC signal comprises a LiFi signal.

21. The luminaire system according to claim 1, wherein the luminaire comprises or forms part of a mobile device.

22. The luminaire system according to claim 1, further comprising a plurality of positionable light emitting units, each light emitting unit comprising a respective one or more of the plurality of outputs.

23. The luminaire system according to claim 22, wherein the at least one guide comprises a plurality of flexible guides configured to guide the modulated radiation to the outputs in the light emitting units, wherein the flexible guides and light emitting units are positionable to form a desired arrangement of light emitting units.

24. The luminaire system according to claim 1, the luminaire system further comprising a signal providing apparatus configured to generate a data signal; wherein the driver apparatus is configured to receive the data signal from the signal providing apparatus, and wherein the driving of the at least one radiation source by the driver apparatus is based on the data signal.

25. The luminaire system according to claim 24, wherein the signal providing apparatus is positioned within a housing of the luminaire system.

26. The luminaire system according to claim 24, wherein the signal providing apparatus comprises or forms part of at least one of a LiFi transmitter, or a LiFi access point.

27. An optical wireless communication (OWC) enabled luminaire system comprising:
at least one receiver;
a plurality of inputs configured to receive light that is modulated to comprise or represent an OWC signal; and
at least one guide configured to guide the received light from the plurality of inputs to the at least one receiver;
wherein the plurality of inputs are positioned at substantially different locations that are remote from the at least one receiver.

28. A method of providing optical wireless communication, comprising:
driving by a driver apparatus at least one radiation source to produce modulated radiation comprising or representing an OWC signal; and
guiding by at least one guide modulated radiation from the at least one radiation source to a plurality of outputs, wherein the plurality of outputs are positioned at substantially different locations that are remote from the at least one radiation source; and
outputting by the plurality of outputs modulated light that comprises or is generated using the modulated radiation produced by the at least one radiation source.

29. An optical wireless communication (OWC) enabled luminaire comprising a driver apparatus and a plurality of light sources coupled to the driver apparatus by at least one wire, wherein:
the driver apparatus is configured to drive the light sources to produce modulated light by transmitting a driving signal on the at least one wire, the modulated light comprising or representing an OWC signal; and
the driver apparatus and light sources are arranged such that light sources are positioned on each side of the driver apparatus with respect to at least one axis of the luminaire.

30. The luminaire according to claim 29, wherein the light sources are arranged along a length of the luminaire.

31. The luminaire according to claim 30, wherein the luminaire is a striplight and the light sources are distributed along a longitudinal axis of the striplight such that light sources are positioned on each side of the driver apparatus with respect to the longitudinal axis.

32. The luminaire according to claim 29, where the driver apparatus is positioned substantially centrally with respect to the at least one axis.

33. The luminaire according to claim 29, wherein the driver apparatus and light sources are arranged to substantially minimise a length of the at least one wire coupling the driver apparatus to the light sources.
